(19) United States
(12) Patent Application Publication
(10) Pub. No.: US 2014/0320640 A1
(43) Pub. Date: Oct. 30, 2014

(54) OPTICAL SYSTEM FOR MEASURING ORIENTATION AND POSITION COMPRISING A POINT SOURCE AND CORNER CUBES WITH A POLYCHROMATIC ENTRY FACE

(71) Applicant: THALES, NEUILLY SUR SEINE (FR)

(72) Inventors: Bruno BARBIER, Bordeaux (FR); Laurent POTIN, Coutras (FR); Siegfried ROUZES, Le Haillan (FR)

(21) Appl. No.: 14/261,383

(22) Filed: Apr. 24, 2014

(30) Foreign Application Priority Data
Apr. 26, 2013 (FR) 1300971

(51) Int. Cl. G01B 11/26; G06T 7/00; G01B 11/14

(52) U.S. Cl. CPC G01B 11/26; G01B 11/14; G06T 7/0042
USPC 348/135

(57) ABSTRACT

The general field of the invention is that of systems for optically detecting the posture of an object which is mobile in space. The system according to the invention comprises an optical assembly comprising a plurality of optical corner cubes arranged on the mobile object. The entry face of the corner cubes is divided into three separate coloured regions having a spectral transmission filter transmitting only a predetermined spectral band different from those of the other filters, each side of the said coloured regions has a specific marking making it possible to identify this said side, and the spectrum of the emission source has a spectral width equal to the sum of the spectral bands of the said filters. The associated fixed electro-optical device of known orientation comprises at least one colour matrix sensor and the image analysis means comprise means for determining shapes and geometrical characteristics in the images received by the colour matrix sensor or sensors.

The field of the invention is that of optical devices making it possible to measure the orientation of an object in space without contact. There are various possible fields of application, but the main application is that of detecting the posture of the helmet of an aircraft pilot, thus making it possible to project an image into his visor in exact superposition on the exterior landscape or to slave various systems of the aircraft under his view. The precision sought in such systems is of the order of one milliradian.

There are various optical techniques for measuring the orientation of a helmet. Generally, conspicuous elements are installed on the helmet, and these are located by a system of cameras. The positions of the images of these conspicuous elements make it possible to determine the orientation of the helmet by calculation.

These elements may be passive or active. Passive elements are illuminated by an external source. To this end, retroreflective corner cubes or retroreflectors may be used. It is sufficient to arrange the optical emission and reception components on the same axis.

These systems with retroreflectors have low sensitivity to sunlight. They are combined with one of the following types of fixed devices:
a camera. In this type of device, however, the quality of the image is degraded in the event of translational movements of the helmet;
a combined objective lens for the illumination and the photography, which provides a large depth of field. The bulk of this type of device is significant;
a point source associated with a matrix sensor without an objective lens.

In the latter two arrangements, the reflector is equipped with a mask which is transmissive in the central part and opaque at the periphery, and which is applied onto its entry face. The contour of the mask is in the shape of a parallelogram, thus embodying the orientation of two fixed directions of the helmet. The orientation of the helmet is calculated by analysing the shape of the contour projected onto the sensor. The analysis relates to the transitions between the light and dark regions of the reflection received by the sensor.

The latter arrangement leads to an optical device which is simple and has a long depth of field. For an elementary corner cube, however, the angular detection field remains limited for the following reasons:
A corner cube reflector offers a theoretical angular field with a solid angle of π/2 steradians, but, as will be seen below, this is reduced greatly by the geometrical constraints of the shape of the mask:
It is possible to combine a plurality of corner cube reflectors. For example, four adjacent reflectors may be associated to form a square-based pyramid, so long as the reflections of the reflectors are distinguished from one another and measurement continuity is ensured from one reflector to another, which presupposes that the reflection exists continuously and has a minimum dimension permitting analysis.

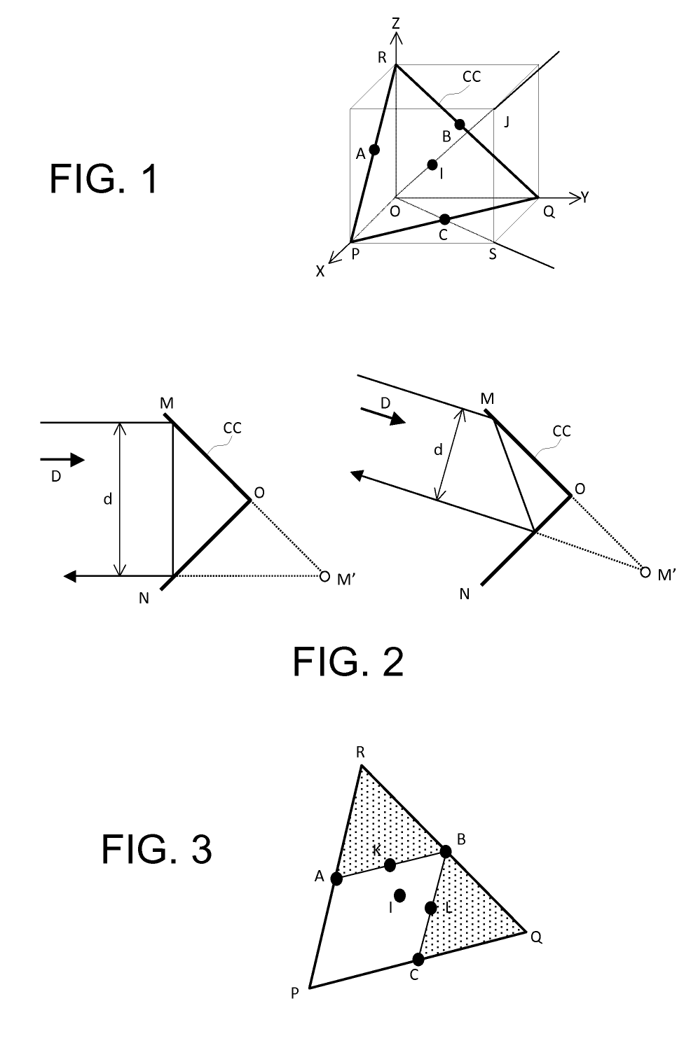

By way of example, a corner cube reflector CC is represented in FIG. 1. It comprises three pairwise orthogonal triangular reflective faces POQ, QOR and POR and a transparent entry face PQR. This face has a mask in the shape of a parallelogram (not represented in FIG. 1). This entry face is, for example, normal to the diagonal OJ of the original cube, the triangle PQR then being equilateral, its centre being the point I.

The angular field of this reflector is limited by the shape of the reflector and by that of the mask, as can be seen in FIG. 2 which represents a sectional view of the corner cube CC. For a given incidence direction D of the light rays on this corner cube, the incident and reflected rays are symmetrical with respect to the vertex O of the corner cube. These two rays are therefore parallel and symmetrical with respect to the axis of direction D which passes through the vertex O. For the direction D, these two rays define the maximum thickness “d” and position of the beam which is fully reflected. This thickness d, which depends on the size of the reflective faces OM and ON, is therefore maximum when the direction D is parallel to the diagonal of the corner cube and zero when the direction D is parallel to one of the reflective faces.

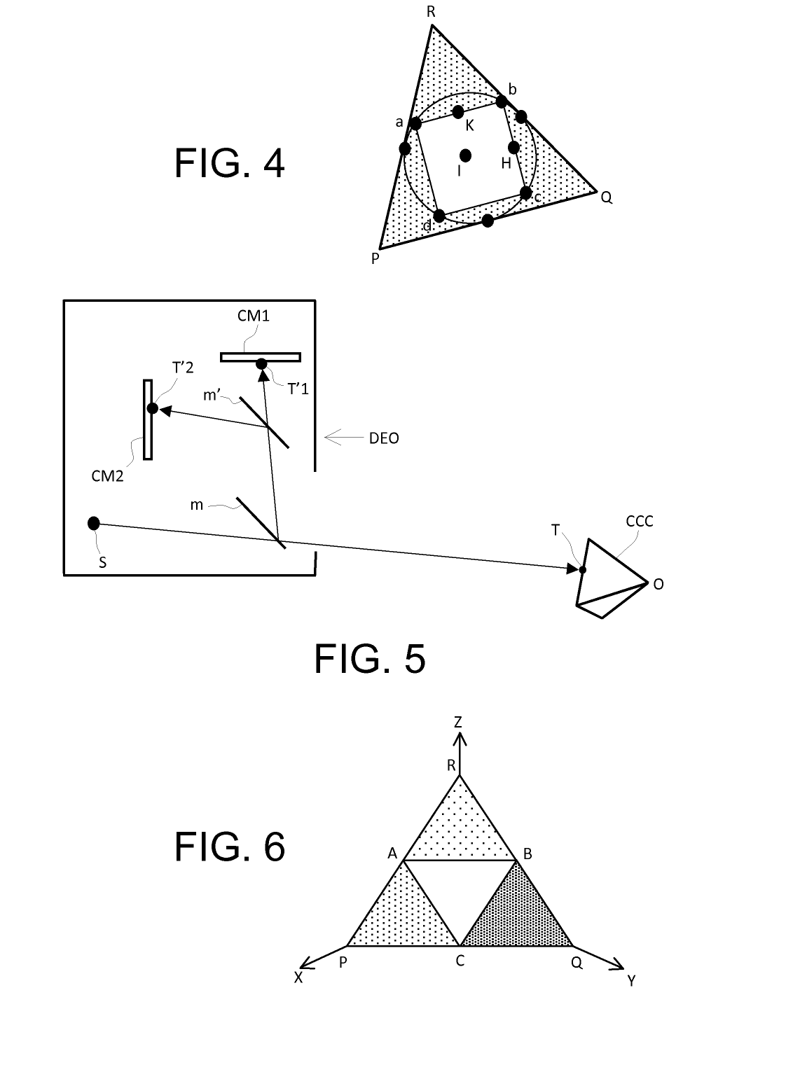

The maximum angular field of the reflector in incidence or in reflection is therefore given by the three reflective planes POQ, QOR and POR. The various values of this angular field can be calculated as a function of the impact point of the central ray passing through the vertex O on the mask. As a first example, for a mask corresponding to the parallelogram ABCP of FIG. 3, which is represented in white in this figure, the angular field with respect to the diagonal OJ is about 55 degrees for the point P, about 35 degrees for the vertices A, B and C, the centres of the sides of the triangle PQR, and only 19 degrees for the centres K and L of the segments AB and BC. As a second example, for a mask corresponding to the square abcd centred in PQR, the vertices of which lie on the circle circumscribed by the triangle PQR of FIG. 4, the angular field is about 35 degrees for the vertices a, b, c, d and 26 degrees for the centres, such as H and K, of each side of the square abcd.

These field limits are significantly far from those corresponding to the angular extent desired around the diagonal OIJ in the half-space bounded by the plane PQR.

The system of the invention overcomes this deficiency. The solid angle obtained is that defined by the vertex O and the entire triangle PQR, that is to say by the three planes of the trirectangular trihedron OXYZ, its value being π/2 steradians.

In order to obtain a large angular field, the system according to the invention comprises corner cubes having the following two original characteristics:
The mask, which occupies the entire surface of the entry face of the reflector, consists of the juxtaposition of coloured pupils, each filtering one particular colour, the reflector being illuminated with white light. The orientation of the helmet is calculated by analysing the shape of the coloured contours, that is to say the boundaries between hues of the polychromatic reflection projected onto the sensor, which is of the colour mosaic type. Each coloured pupil contributes to covering a part of the angular field, and together they cover a desired extent of π/2 sr;
Specific encoding carried out by local marking is applied to the detail of the contour, to the colour and to the optical transmission of the coloured regions of the pupils of each reflector. The matrix detector operates no longer in binary mode, but on a plurality of colour hue levels. The encoding makes it possible to distinguish a great variety of different reflections. This property is exploited in order to distinguish both the reflectors and also the reflections coming from two neighbouring reflectors and superposed on the sensor.

Compact combinations of reflectors according to the invention make it possible to ensure measurement of the position detection in a large angular extent.

Furthermore, the analysis method is sensitive neither to luminous power variation of the source nor to variation in its colorimetry, nor source/reflector distance variation due to the position of the helmet.

More precisely, the invention relates to a system for detecting the posture of an object which is mobile in space, comprising a fixed electro-optical device of known orientation comprising at least a first emission source, image analysis means and an optical assembly comprising at least one optical corner cube arranged on the mobile object, characterized in that:
the entry face of the corner cube is divided into at least three separate coloured regions, each coloured region having a spectral transmission filter, each filter transmitting only a predetermined spectral band different from those of the other spectral transmission filters;
each side of the said coloured regions having a specific marking making it possible to identify this said side;
the spectrum of the emission source having at least a spectral width equal to the sum of the spectral bands of the said spectral transmission filters;
the fixed electro-optical device of known orientation comprises at least one colour matrix sensor sensitive to the spectral band of the emission source;
the image analysis means comprise means for determining shapes and geometrical characteristics in the images received by the colour matrix sensor.

Advantageously, the entry face of the corner cube being triangular, it is divided into three identical coloured triangular regions.

Advantageously, the entry face of the corner cube been triangular, it has three identical coloured triangular regions enclosing a transparent triangular central region without a spectral transmission filter.

Advantageously, the specific markings are geometrical and/or photometric markings.

Advantageously, in a first embodiment, the optical assembly has four adjacent tetrahedral corner cubes of identical shapes, each corner cube having one entry face, two reflective lateral faces common to two other corner cubes, and a reflective third lateral face located in a plane common to the other third lateral faces of the three other corner cubes, the said third lateral faces thus forming a square, the four entry faces and the said square forming a pentahedron in the form of a square-based pyramid. In an alternative arrangement, the optical assembly has four tetrahedral corner cubes of identical shapes arranged symmetrically around a single vertex common to the four corner cubes, each corner cube having one entry face. In a first variant, the entry faces of the first and second corner cubes comprise the same first triplet of coloured regions, and the entry faces of the third and fourth corner cubes comprise the same second triplet of coloured regions, which is different from the first triplet of coloured regions. The specific marking of the sides of the coloured regions of each entry face is arranged in such a way that this face can be distinguished from the three others. In a second variant, the entry faces of the four corner cubes comprise the same first triplet of coloured regions and the entry faces of the first and second corner cubes have a neutral filter of predetermined transmission.

Advantageously, in a second embodiment, the optical assembly has eight adjacent tetrahedral corner cubes of identical shapes, each corner cube having one entry face, and three reflective lateral faces common to three other corner cubes, the eight entry faces forming a regular octahedron. In a first variant, the entry faces of the eight corner cubes comprise the same first triplet of coloured regions and the entry faces of the four corner cubes have a neutral filter of predetermined transmission. In a second variant, the entry faces of the first, second, third and fourth corner cubes comprise the same first triplet of coloured regions, and the entry faces of the fifth, sixth, seventh and eighth corner cubes comprise the same second triplet of coloured regions, which is different from the first triplet of coloured regions. The specific marking of the sides of the coloured regions of each entry face is arranged so that this face can be distinguished from the seven others.

Advantageously, in a third embodiment the optical assembly has a plurality of corner cubes, the entry faces of which are oriented and positioned along the pentagonal faces of a regular dodecahedron or of a part of a dodecahedron, each entry face being oriented in each pentagonal face so that the optical assembly produces a reflection on the detector in a range of determined orientation, the specific marking of the sides of the coloured regions of each entry face being arranged so that this entry face can be distinguished from all the others.

Advantageously, the fixed electro-optical device has at least one point emission source and only optical components having a zero or quasi-zero optical power, that is to say plane mirrors or semi-reflective plane plates, the separation between the point emission source and the light reflected by the corner cube or cubes been produced by means of a semi-reflective plane plate.

Advantageously, the analysis means comprise electronic preprocessing arranged at the output of the matrix sensors and making it possible to assign a three-component code to each pixel, each component being representative of a predetermined spectral band, each component being encoded over a limited number of levels representing the absence or presence of light received in the said spectral band.

The invention also relates to a flight helmet comprising at least one optical corner cube, the entry face of which is divided into at least three separate coloured regions, each coloured region having a spectral transmission filter, each filter transmitting only a predetermined spectral band different from those of the other spectral transmission filters, each side of the said coloured regions having a specific marking making it possible to identify this said side, the said corner cube being intended to operate in a system for detecting the posture of a mobile object as defined above.

Advantageously, in a first variant, the helmet comprises at least one regular dodecahedron having a plurality of identical pentagonal faces, each having a corner cube arranged so that the entry face of the said corner cube is located on one of the said pentagonal faces and each entry face is oriented in each pentagonal face so that the optical assembly produces a reflection on the detector in a range of determined orientation, the specific marking of the sides of the coloured regions of each entry face being arranged so that this entry face can be distinguished from all the others.

Advantageously, in a second variant, the helmet comprises at least two identical regular semi-dodecahedra, each having six identical pentagonal faces, each having a corner cube arranged so that the entry face of the said corner cube is located on one of the said pentagonal faces and each entry face is oriented in each pentagonal face so that the optical assembly produces a reflection on the detector in a range of determined orientation, the specific marking of the sides of the coloured regions of each entry face being arranged so that this entry face can be distinguished from all the others.

The invention will be understood more clearly, and other advantages will become apparent, on reading the following description which is given without implying any limitation, and by virtue of the appended figures, in which:

FIG. 1 illustrates the problem of angular limitation in a corner cube;

FIGS. 2, 3 and 4 represent various possibilities for geometrical masks arranged on the front face of a corner cube according to the prior art;

FIG. 5 represents a diagram of the optical posture detection system according to the invention;

FIG. 6 represents a first corner cube with a polychromatic entry face according to the invention;

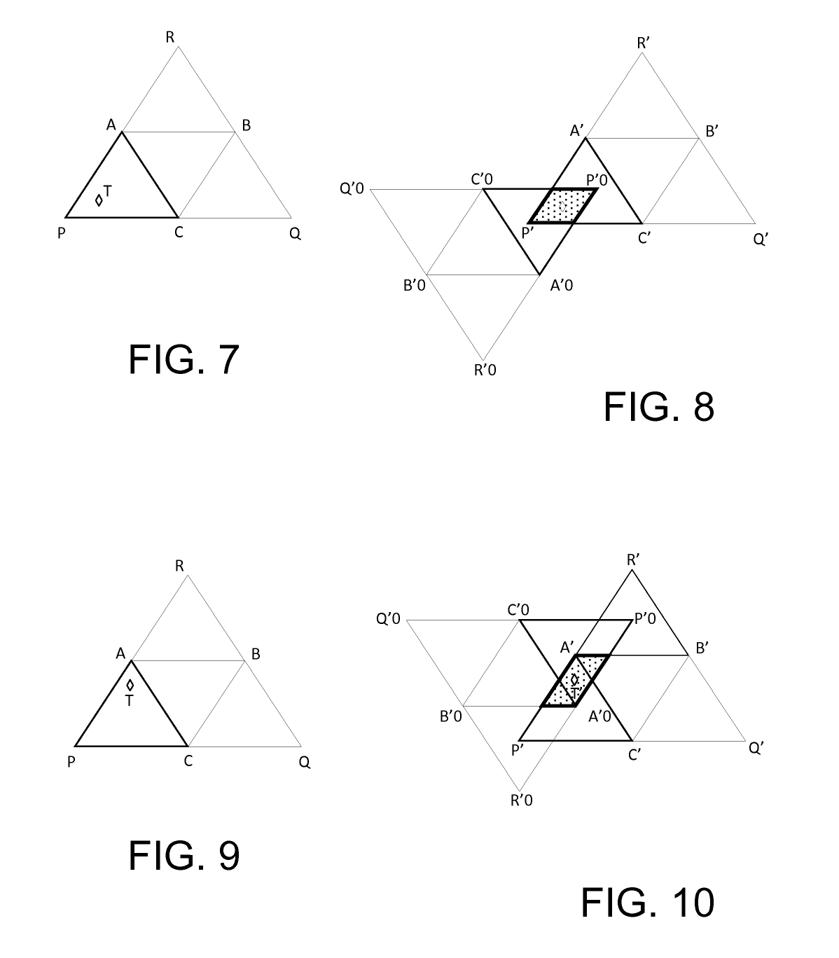

FIGS. 7 to 14 represent the geometry of the figures reflected back by this first corner cube, and their colours, as a function of the position of the point T of intersection on the plane of the entry face of the straight line joining the point source at infinity and the vertex of the reflector;

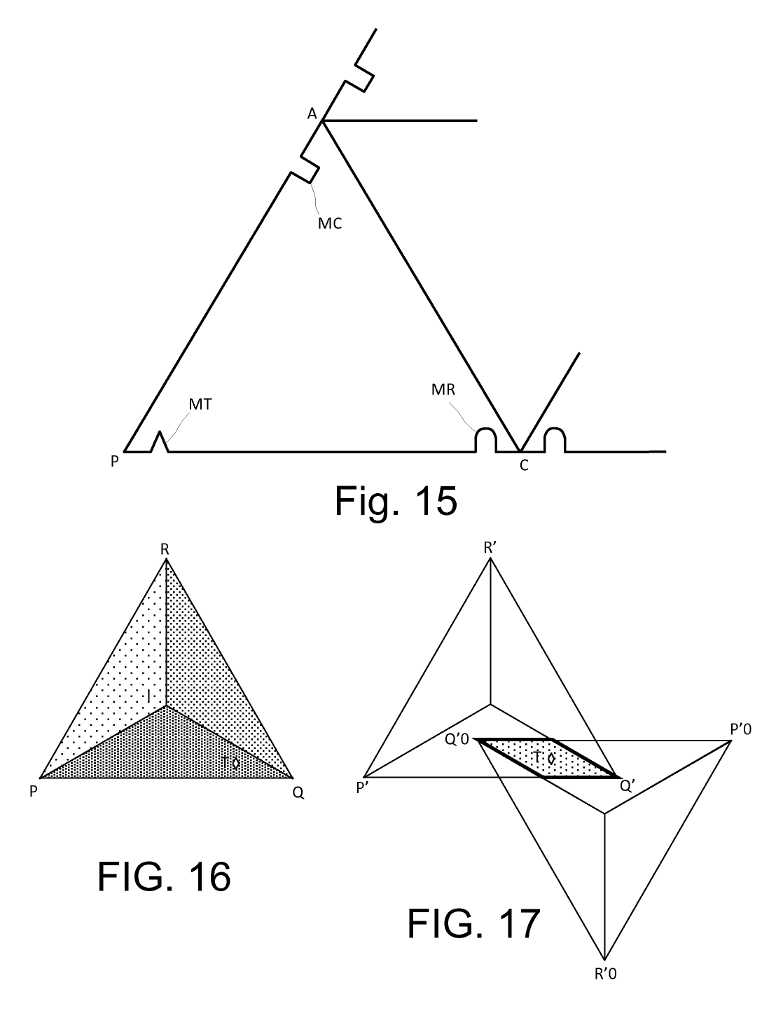

FIG. 15 represents a first geometrical shape of the marking of the sides of the coloured triangles forming the entry face of a corner cube;

FIG. 16 represents a second corner cube with a polychromatic entry face according to the invention;

FIGS. 17 to 19 represent the geometry of the figures reflected back by this second corner cube, and their colours, as a function of the position of the point T of intersection on the plane of the entry face of the straight line joining the point source at infinity and the vertex of the reflector;

FIG. 20 represents a perspective view of a pyramidal assembly of four corner cubes according to the prior art;

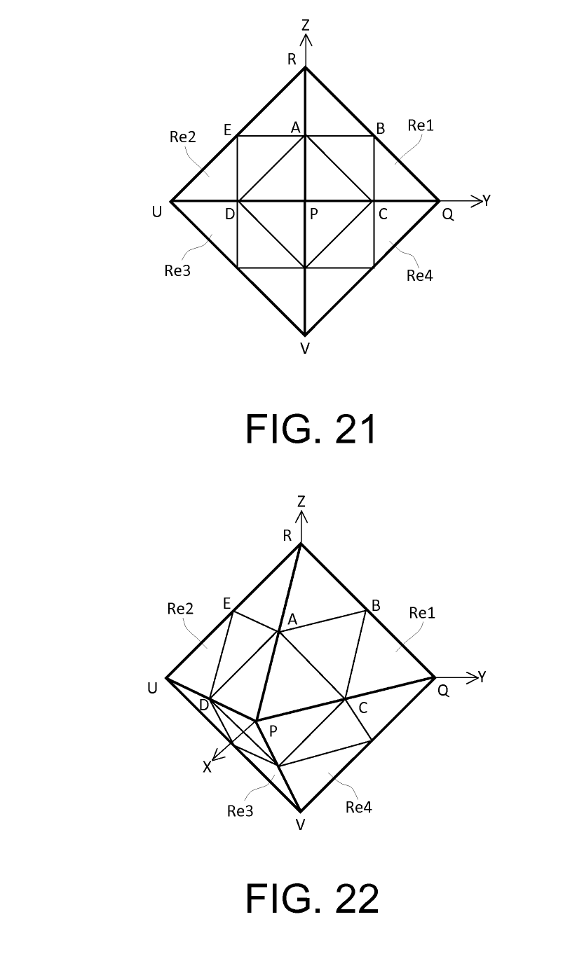

FIGS. 21 and 22 represent a view from above and a perspective view of an assembly with four corner cubes according to the invention;

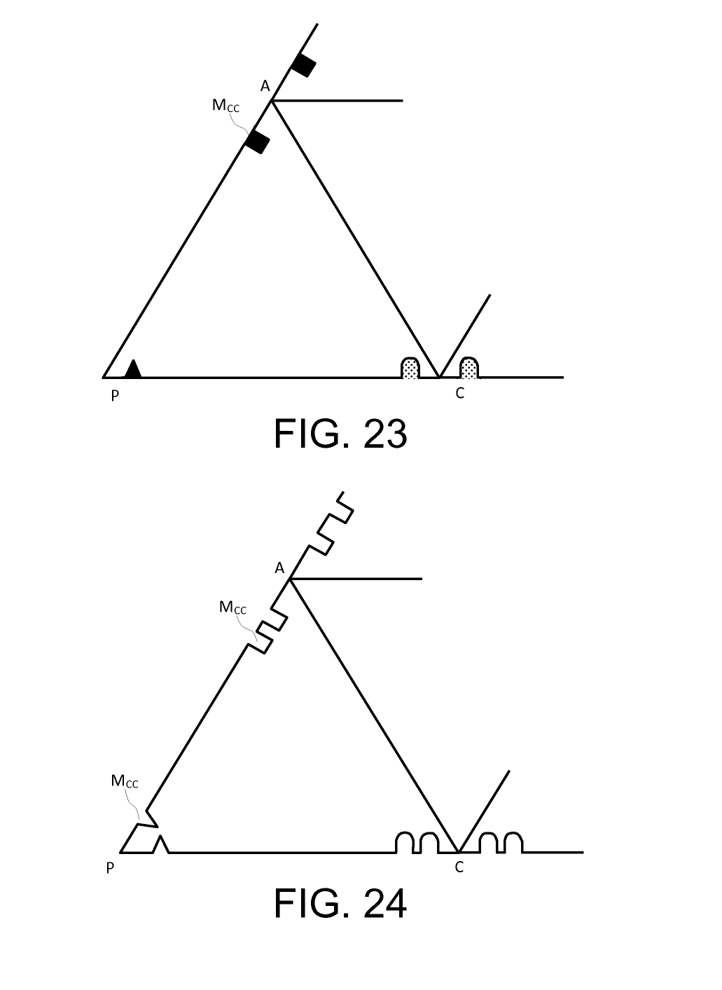

FIGS. 23 and 24 represent two variants of the marking of the sides of the coloured triangles forming the entry face of the corner cubes of the preceding pyramidal assembly;

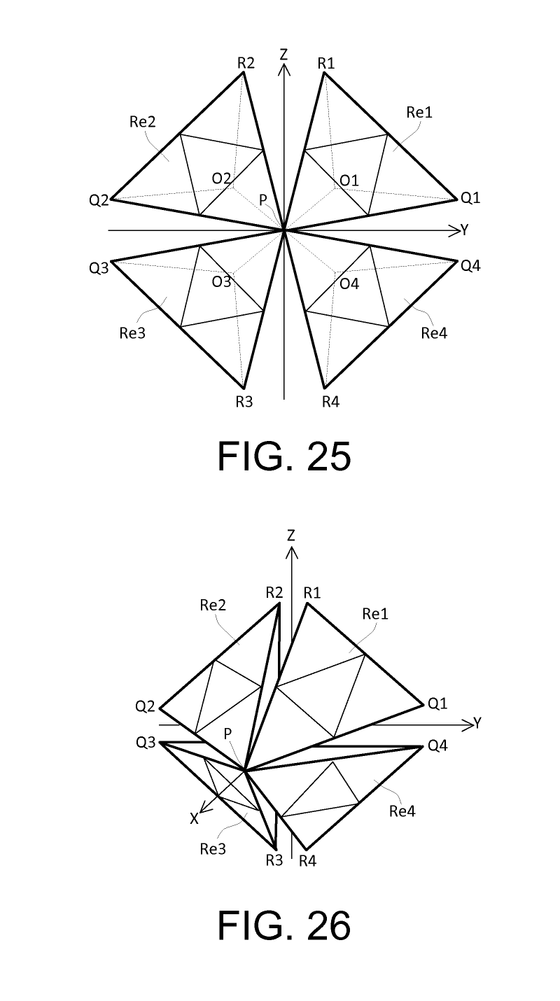

FIGS. 25 and 26 represent a view from above and a perspective view of a variant of the assembly of four corner cubes in FIGS. 21 and 22;

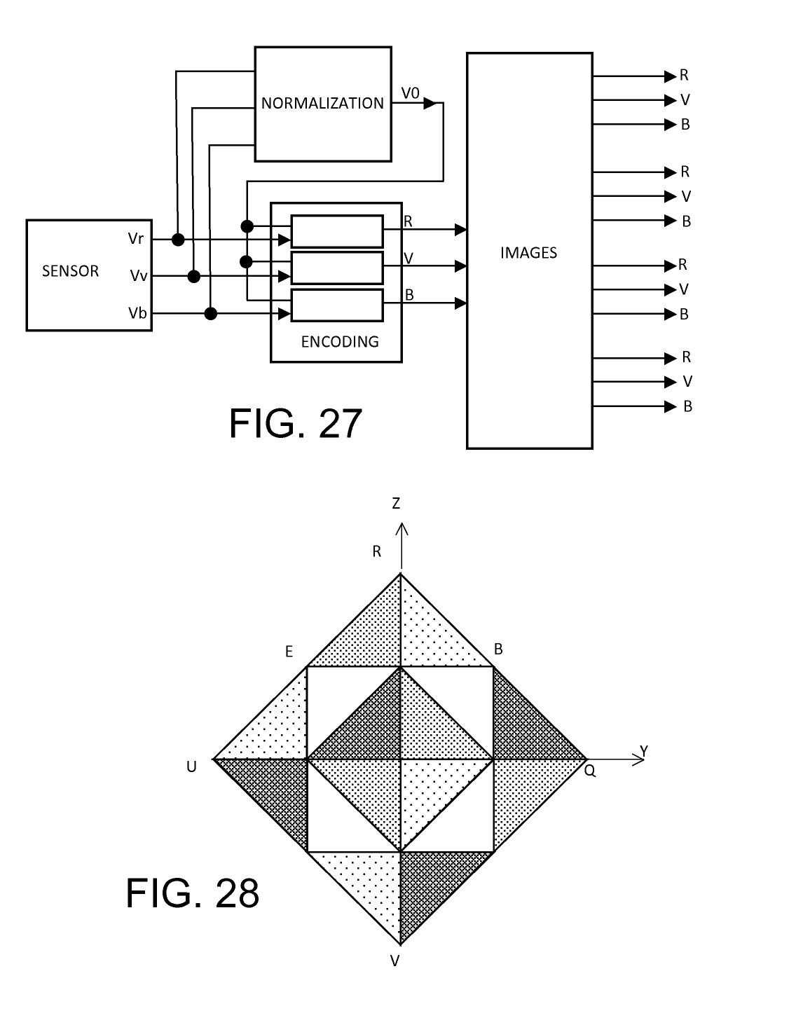

FIG. 27 represents a circuit diagram of a part of the image analysis means of a detection device according to the invention;

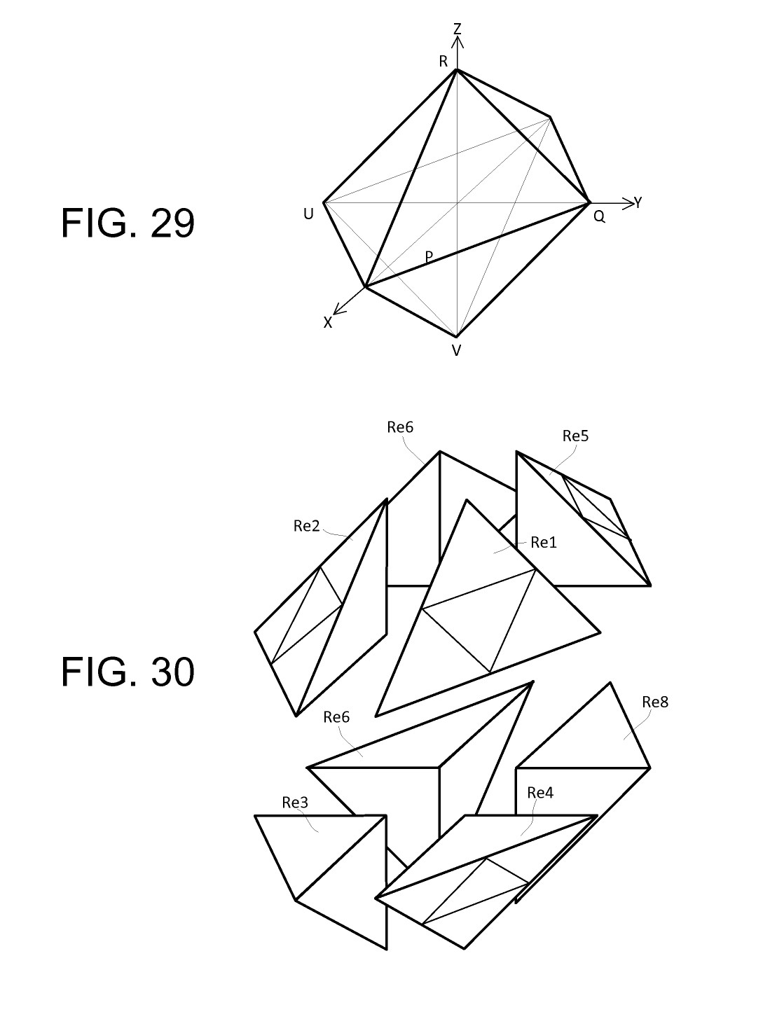

FIG. 28 represents a possible distribution of the coloured regions of the entry faces of the four corner cubes of the preceding pyramidal assembly;

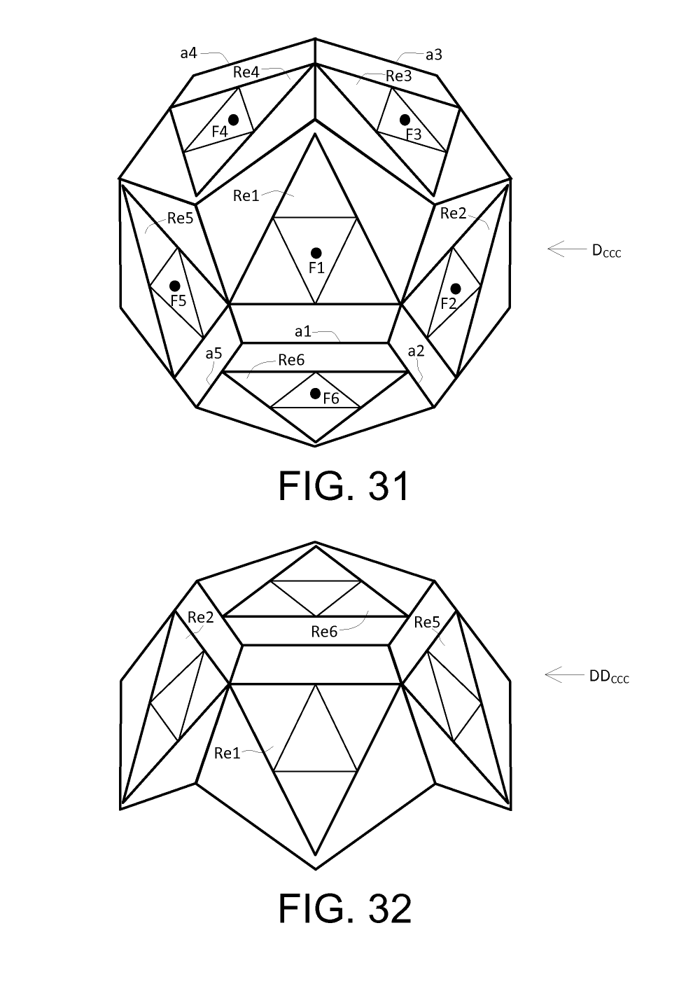

FIGS. 29 and 30 represent a perspective view and an exploded view of an assembly of eight corner cubes according to the invention in the shape of an octahedron;

FIG. 31 represents a perspective view of an assembly of twelve corner cubes according to the invention in the shape of a dodecahedron;

FIG. 32 represents a perspective view of an assembly of six corner cubes according to the invention in the shape of a semi-dodecahedron;

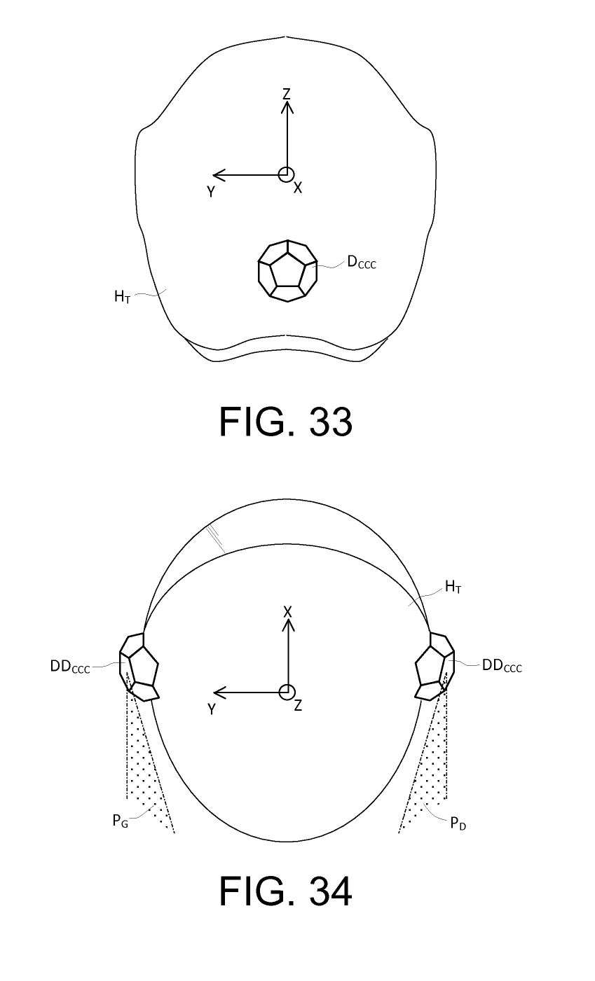

FIGS. 33 and 34 represent views from the back and from above of a helmet comprising assemblies of polychromatic corner cubes according to the invention.

In what follows, a first part of an optical detection system according to the invention comprising a single reflective corner cube will be dealt with. A second part deals with a detection system comprising an optical assembly comprising a plurality of associated corner cubes.

Part One: Detection System Unique with a Single Corner Cube

The detection system for optical detection of the posture of an object which is mobile in space according to the invention comprises a fixed electro-optical device of known orientation, image analysis means, and an optical assembly comprising at least one polychromatic optical corner cube arranged on the mobile object. The core of the device is the polychromatic corner cube. This corner cube can operate with various electro-optical devices. Notably, mention may be made of devices comprising white light emission sources and colour reception cameras. However, it is particularly suitable for an electro-optical device with a point white light source.

An example of this type of device is represented in FIG. 5. The electro-optical device DEO comprises a point source S with an extended spectrum, referred to as a “white” source, two semitransparent mirrors m and m′, and two colour image matrix sensors CM1 and CM2. The image of the sensor CM1 by reflection on the semi-reflective plate m′ is offset from the sensor CM2. The point source S illuminates a coloured corner cube CCC. The coloured figure re-emitted by the corner cube is received by the two matrix sensors CM1 and CM2. Thus, the point of impact T on the entry face of the corner cube gives two image points T′1 and T′2. Comparison and analysis of these two figures, which are perspective views of the images of the entry faces of the corner cubes obtained by reflection on the plane mirrors constituting the corner cube, makes it possible to find both the orientation and the position of the corner cube.

In the rest of the description, the component CCC will be referred to arbitrarily as a corner cube or reflector. The corner cube is secured to the mobile object. In aeronautical applications, the mobile object is a helmet. The corner cube may be a solid reflector, in which case the reflection on the internal faces of the corner cube takes place by total internal reflection. It may also be formed by assembling three plane mirrors arranged orthogonally to one another. In the rest of the description, unless otherwise specified, the corner cubes may equally well be solid or not.

The device according to the invention can also operate with electro-optical devices having only a single matrix sensor.

The entry face of the corner cube CCC is divided into at least three separate coloured regions each coloured region having a spectral transmission filter. By way of example, an entry face according to the invention is represented in FIG. 6. The different colours are represented by dots of different density.

In what follows, the following colorimetry conventions have been adopted. The visible spectrum is divided into three large spectral bands referred to as “red”, “green” and “blue”, from the longest wavelengths to the shortest wavelengths. A red-coloured filter transmits only the red spectral band and filters out the green and blue spectral bands. The complementary colours, referred to as “magenta”, “cyan” and “yellow” have as respective spectral bands:
magenta band: sum of the red and blue bands;
cyan band: sum of the green and blue bands;
yellow band: sum of the red and green bands.

The spectral positioning and the width of the bands are, of course, adapted according to the spectral sensitivity of the matrix sensors. It is possible to adapt the detection system for operation in other spectral distributions, such as the near infrared. It is sufficient to keep the three different spectral bands and to adapt the filters and the sensitivity of the sensor accordingly.

Analysis of the coloured images coming from the matrix sensors, and in particular their vanishing lines, makes it possible to find the position and the orientation of the corner cube CCC.

As mentioned, the particular feature of the corner cube according to the invention is that it has a polychromatic front face. Various arrangements of the coloured regions of this front face exist. In a first embodiment, illustrated in FIGS. 6 to 14, the entry face PQR of the corner cube is triangular and has three identical coloured triangular regions enclosing a transparent triangular central region without a spectral transmission filter. More precisely, the transparent surface of the entry face of the corner cube delimited by the triangle PQR comprises:
a red filter, that is to say one which is transparent for red wavelengths only on the surface bounded by the triangle PAC;
a green filter, that is to say one which is transparent for green wavelengths only on the surface bounded by the triangle RAB;
a blue filter, that is to say one which is transparent for blue wavelengths only on the surface bounded by the triangle BQC;
no filter on the surface bounded by the triangle ABC, which is therefore completely transparent.

With this arrangement of the entry face, the following effect is obtained:
the red part of the radiation coming from the source enters and emerges from the reflector only through the inside of the rhombus PABC;
the green part of the radiation coming from the source S enters and emerges from the reflector only through the inside of the rhombus RACB;
the blue part of the radiation coming from the source enters and emerges from the reflector only through the inside of the rhombus QCAB.

In the image projected onto each sensor, only red, green, blue or white surfaces of homogeneous colour are therefore found, these surfaces not being mixed and having no composite colour obtained by superposition. These surfaces are adjacent and have no intermediate black regions. In the rest of the description, a “colour dominant” surface denotes the surface resulting from the juxtaposition of a surface of pure colour, either red, green or blue, and a white surface. “Red dominant”, “green dominant” or “blue dominant” surfaces are therefore obtained. At the pixels of the sensors, these “colour dominant” surfaces are characterized as follows:
Inside the red dominant surface, all the pixels reproducing the colour red are lit;
Inside the green dominant surface, all the pixels reproducing the colour green are lit;
Inside the blue dominant surface, all the pixels reproducing the colour blue are lit;
Outside the red dominant surface, no pixel reproducing the colour red is lit;
Outside the green dominant surface, no pixel reproducing the colour green is lit;
Outside the blue dominant surface, no pixel reproducing the colour blue is lit.

The contour of each of these three colour dominant surfaces is a parallelogram if the source is at infinity, or a quadrilateral in the general case of a source at a finite distance. Each surface is produced by:
blocking of the incident radiation outside a surface of parallelogram contour;
then blocking the radiation by the mirror image of this surface with respect to the vertex O of the corner cube reflector;
then projection towards the source onto the analysis sensors.

More precisely,
the quadrilateral bounding the red dominant surface is the product of the operation of blocking/projecting the rhombus PABC and its mirror image;
the quadrilateral bounding the green dominant surface is the product of the operation of blocking/projecting the rhombus RACB and its mirror image;
the quadrilateral bounding the blue dominant surface is the product of the operation of blocking/projecting the rhombus QCAB and its mirror image.

The shape of the contour and the colour of surfaces obtained on the sensors depend on the incidence of the radiation produced by the source S on the reflector, and more precisely on the position of the point T of intersection on the plane PQR of the straight line OS joining the source S and the vertex O of the reflector. For example, the image on the detector contains red if and only if the point T lies inside the rhombus ABCP.

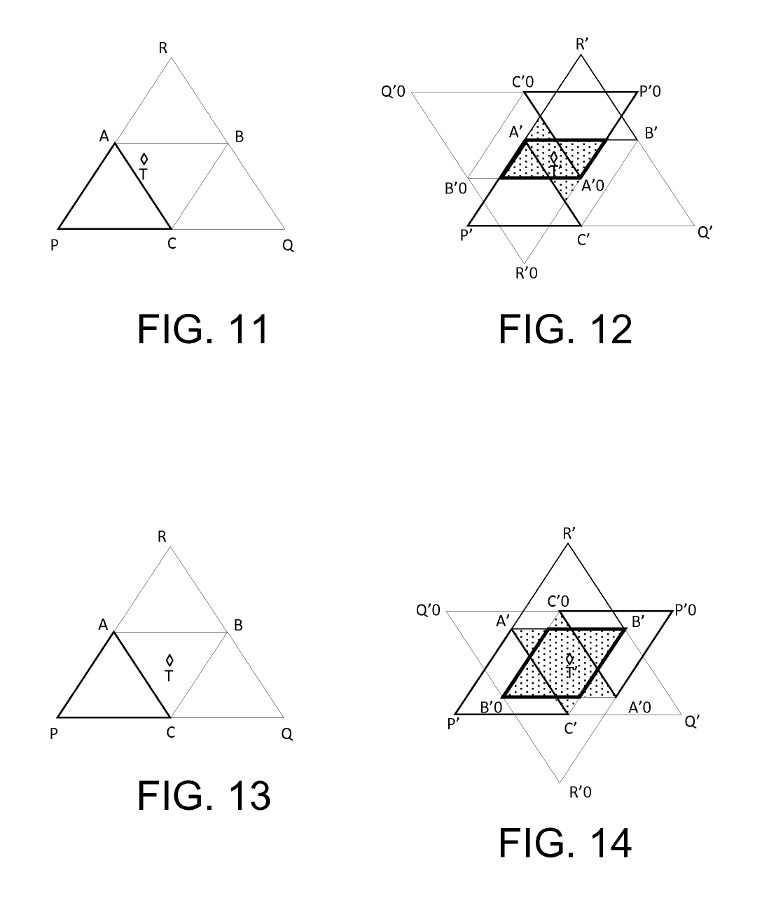

By way of examples, FIGS. 7 to 14 describe the various images obtained depending on the position of T in the red rhombus ABCP. Of course, the same reasoning applies to the two other regions coloured green and blue. FIGS. 7, 9, 11 and 13 indicate the position of T in the rhombus ABCP, which are:
in FIG. 7, the point T lies in the red-transmission triangle PAC and close to the vertex P;
in FIG. 9, the point T lies in the red-transmission triangle PAC and close to the vertex A;
in FIG. 11, the point T lies in the total-transmission triangle ABC and close to the vertex A;
in FIG. 13, the point T lies in the total-transmission triangle ABC and close to the centre.

FIGS. 8, 10, 12 and 14 give the corresponding images obtained on the detectors, the source S being at infinity. For these figures, the following representation was adopted:
the points P′, A′, B′, C′ and T′ are the cavalier projections in the direction OS of the points P, A, B, C and T onto the plane of the detector;
the points P′0, A′0, B′0 and C′0 are the projections of the points P0, A0, B0 and C0, not represented in the figures, which are the virtual images of the points P, A, B and C produced by the reflector of vertex O. These points P0, A0, B0 and C0 are mirror images of the points P, A, B and C with respect to 0:
the parallelism is preserved and the points P′0, A′0, B′0, C′0 are the mirror images of the points P′, A′, B′, C′ with respect to T′.

In FIGS. 8, 10, 12 and 14, the dotted region corresponds to the luminous part of the region of intersection of the triangles P′Q′R′ and P′0Q′OR′0. The region in bold lines gives the contour of the red dominant surface present in the four images. The contour of this surface always contains the image of one of the vertices, namely P′ in FIG. 8, A′ in FIGS. 10 and 12, and B′ in FIG. 14. Consequently, this contour always contains the image of two sides converging on this vertex. This red dominant surface is a parallelogram, of which the direction of one of the sides and the position of the intersection of the diagonals gives the orientation of the corner cube. In the case of a source S at a finite distance, this surface is a quadrilateral of which the circumcentres of the sides taken pairwise are the two vanishing points of the unknown directions AP and AB, for the projection of the unknown centre S0 which is the mirror image of the source S with respect to the vertex O, which is also unknown.

By carrying out projection into the two planes of the sensors CM1 and CM2 of the images reflected by the corner cubes, these planes being different and of known positions and orientations, two different quadrilaterals are obtained. From knowledge of the position on each sensor of the two vanishing points of the same projected rhombus, the position of the vertex O of the reflector and the orientation of two of the adjacent sides of the corresponding initial rhombus are deduced. The orientation of the position of the mobile object is thus obtained.

So long as the orientation of the reflector is such that the intersection T between the straight line SO joining the source S to the vertex O of the reflector and the plane PQR remains inside the triangle PQR, there is at least one quadrilateral imaged onto the detectors. This quadrilateral is:
red dominant, if T is in the rhombus PABC,
green dominant, if T is in the rhombus RABC,
blue dominant, if T is in the rhombus QABC.

This arrangement allows a significant increase in the angular detection field in so far as all of the entry surface of the corner cube, and no longer a partial mask, is now taken into account in the detection. For a corner cube according to the invention, the total angular field obtained is π/2 steradians.

If the point source is not at infinity, the parallelograms of the dominant coloured surfaces are deformed into quadrilaterals. The point T′ remains the circumcentre common to the segments P′0P′, A′0A′, B′0B′, C′0C′, but without being at the centre.

The same filtering method is applicable, by means of simple adjustments, with the same mosaic image sensors by using a reflector provided with less spectrally selective filters. For example, yellow, cyan and magenta dominant filters may be used. The projected quadrilaterals are also yellow, cyan and magenta dominant.

If simple coloured triangles are used, it is difficult to determine the sides of the triangle involved in the measurement. In order to distinguish the sides, a specific marking is added to them in the proximity of each vertex of the triangles PAC, RAB and QBC. On the projected image contour of a given dominant colour, the original vertex and one of the two sides converging on this vertex are thus identified. Various types of geometrical, photometric or colorimetric marking may be used. For example, small local maskings of different shape may be produced. FIG. 15 represents this type of marking carried out on the triangle APC. The marks are as follows:
Mark MT of triangular shape in proximity to the vertex P on the side PC;
Mark MC of square shape in proximity to the vertex A on the side AP;
Mark MR of semicircular shape in proximity to the vertex C on the side CP.

The same marking as that of the triangle APC is carried out for the two other triangles RAB and BCQ, respectively green and blue.

For the projected images which do not have marking, such as the luminous dodecagon of FIG. 14, the original vertices are distinguished with the aid of the particular colour produced in proximity to each acute-angled vertex of this dodecagon, namely the vertices A′, B″C′, A″0, B′0, C′0.

In a second embodiment, illustrated in FIGS. 16 to 19, the entry face PQR of the corner cube is triangular and has only three identical coloured triangular regions. As an example, illustrated in FIG. 16, the three regions have cyan, magenta and yellow filters of triangular shape on the front face PQR of centre I. Here again, the various colours are represented by different densities of dots.

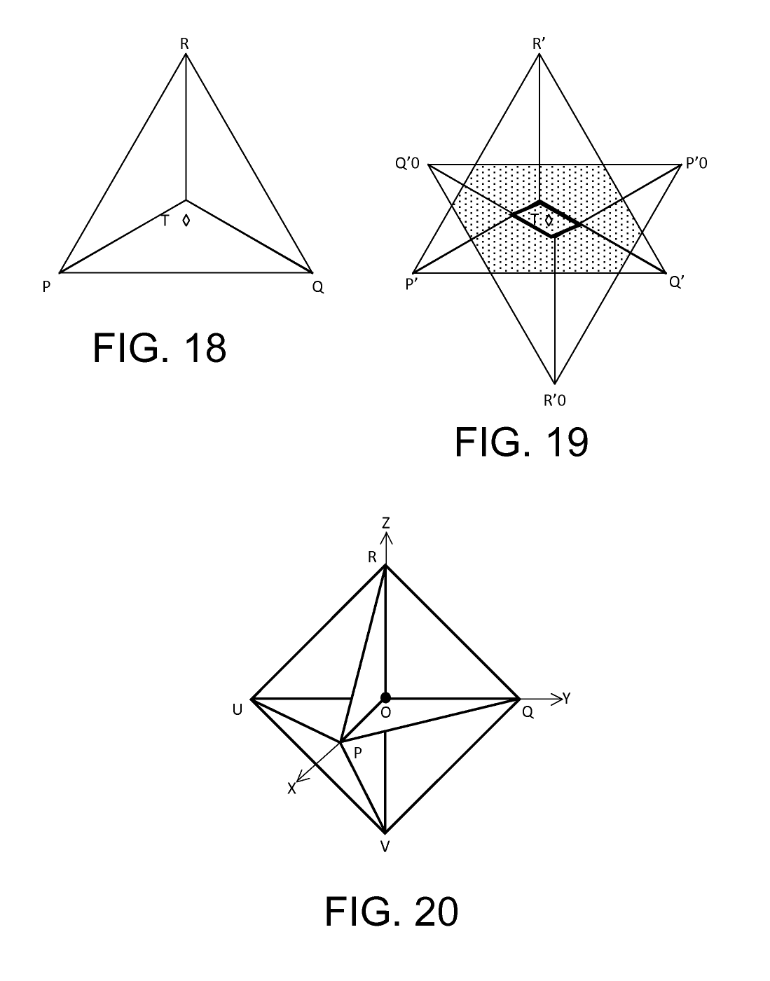

The luminous surface obtained on the detector, for a source S at infinity, varies according to the position of the point T defined as above and positioned, for example, inside the magenta triangle PIQ. It is represented in FIGS. 17 and 19 by dots, for two positions of the point T which are represented in FIGS. 16 and 18. The parallelograms enclosed by a bold contour indicate the boundary of the magenta region.

For the first position of T close to the point Q, the surface represented in FIG. 17 is a two-coloured red/magenta parallelogram of which the first direction common to the red/black and magenta/black boundaries is parallel to the side PQ, the magenta/black boundary of the magenta triangle PIQ, and the second direction of the red/black boundary is parallel to the side RO, the yellow/black boundary of the yellow triangle RIQ.

For the second position of T close to the point I, the surface represented in FIG. 19 is a four-coloured magenta, red, green and blue hexagon of which the first direction common to the red/black and blue/black boundaries is parallel to the side PQ, the magenta/black boundary of the magenta triangle PIQ, and the second direction common to the red/black and green/black boundaries is parallel to the side RQ, the yellow/black boundary of the cyan triangle QIR.

Part Two: Detection System Comprising a Plurality of Corner Cubes

Even though an optical detection system having a single coloured corner cube according to the invention has an angular field greater than that of a system having a corner cube with a parallelogram contour mask, it may be insufficient in a certain number of applications which require a large angular range. This is the case, notably, with helmet posture detection systems. The simplest procedure is to arrange an optical assembly, having a plurality of corner cubes arranged so as to cover a wide angular sector, on the mobile object. This arrangement also has the advantage that, under certain conditions, the system can function with a single emission and reception device.

The combination of a plurality of corner cubes is known. For instance, U.S. Pat. No. 6,123,427 entitled “Arrangement for retroreflection of a ray using triple prisms” describes a plurality of optical combinations having from six to ten reflectors. U.S. Pat. No. 3,039,093 entitled “Reflective radar target” describes an arrangement having twenty reflectors. Lastly, patent FR 78 24013 entitled “Dispositif optoléctronique de detection et de localisation d′objet et système de repérage spatial de direction comportant un tel dispositif” [Optoelectronic device for object detection and localization and spatial direction identification system comprising such a device] describes, for applications in the same technical field as the invention, a combination of four corner cubes which are adjacent along two of their reflective faces so as to widen the angular field. FIG. 20 represents a perspective view of this combination of four corner cubes in a trirectangular trihedron (O, X, Y, Z).

These various combinations, however have several significant drawbacks for our application, which are detailed below:
The corner cubes described in the prior art are all identical. Distinguishing between the reflections of the corner cubes is therefore not described;
In the case of a reflector consisting of three orthogonal mirrors, such as that represented in FIG. 20, in contrast to the case of a solid reflector with three faces in total internal reflection, no radiation is reflected towards the detector when the source is positioned on one of the two planes XOY and XOZ common to two reflectors;
Particular distinguishing of the reflections is not described either when the source is positioned on one of the two separation planes of the reflectors, such as XOY and XOZ.

The corner cube combinations described below all have corner cubes whose triangular entry face has three identical coloured triangular regions surrounding a transparent central triangular region. An example of this type of entry face is represented in FIG. 6. Of course, by means of adaptations within the scope of the person skilled in the art, it is possible to produce corner cube combinations whose triangular entry face has only three identical coloured triangular regions. An example of this type of entry face is represented in FIG. 16.

A first advantageous corner cube combination consists in combining four adjacent corner cubes denoted Re1, Re2, Re3 and Re4, such as those described in FIGS. 21 and 22. FIG. 21 represents a view from below, along OX, of the optical assembly with four corner cubes, and FIG. 22 represents a perspective view of the same optical assembly. In this arrangement, the four entry faces and the plane ZOY common to one lateral face of each reflector form a pentahedron PRQUV, that is to say a square-based pyramid. The face RUVQ is a square, and the entry faces PQR, PUR, PUV and PVQ are equilateral triangles. Each corner cube reflector is provided with three coloured triangular filters with marking and one neutral filter, as described above. The filters of the corner cubes Re1 and Re2 are delimited by the points A, B, C, D and E in FIGS. 21 and 22.

It is necessary to distinguish the reflectors from one another. One possible way of distinguishing them is obtained by combining corner cubes with different polychromatic filters. For example, the reflectors Re1 and Re3 are equipped with red, green and blue triangular filters and a neutral central triangle. The reflectors Re2 and Re4 are equipped with cyan, magenta and yellow triangular filters and a neutral central triangle.

The reflections generated by the corner cubes Re1 and Re3 are distinguished from those of the corner cubes Re2 and Re4 by the absence of the three colours cyan, magenta and yellow in the projected image. The reflections generated by Re2 and Re4 are distinguished from those of Re1 and Re3 by the presence of at least one of the three colours cyan, magenta and yellow in the projected image.

In order to identify the source reflector from the isolated reflection of a given colour, that is to say in order to choose between the two corner cubes Re1 and Re3 or between the corner cubes Re2 and Re4, additional differentiation is added on the markings of the faces of the corner cubes. As examples, this additional differentiation is obtained:
As represented in FIG. 23, by intermediate transmission levels in the marks M_{CC}. The optical transmission in the mark added on the coloured filter at the edge of its contour therefore has two predetermined values. In FIG. 23, the marks with weak transmission are represented in black;
As represented in FIG. 24, by doubling the marking.

For the projected images which do not contain marking, the differentiation is carried out by the sense of the sequencing of the colours surrounding the white transparent surface. Thus, on the image provided by Re1, the sequence red, green, blue surrounding the transparent surface follows the anticlockwise sense, whereas it follows the clockwise sense for Re3. On the image provided by Re2, the sequence magenta-yellow-cyan surrounding the white surface follows the anticlockwise sense, whereas it follows the clockwise sense for Re4.

For a given reflector the existence of a reflection is ensured so long as there is a vertex/source ray SO inside the trihedron formed by its three reflective faces. In order to ensure on the one hand the existence and on the other hand a minimum dimension of the reflection when the source is in the vicinity of one of the two planes XOY and XOZ, the configuration of the four corner cubes is modified. Relative to the arrangement of FIGS. 21 and 22, each of at least two, but preferably each of the four corner cubes individually experiences a rotation of a few degrees and a translation along the axes OY and OZ, which moves it away from these two neighbours and thus allows rotation of the reflectors. For example, FIG. 25 represents a view from above of the modified optical assembly with four corner cubes and FIG. 26 represents a perspective view of the same modified optical assembly. The four reflectors Re1, Re2, Re3 and Re4 are defined respectively by the quadruplets of points (O1, Q1, R1, P), (O2, Q2, R2, P), (O3, Q3, R3, P) and (O4, Q4, R4, P). They are all identical, they all have the same common vertex P and are symmetrical with respect to the axes OY and OZ.

In this case, the source S must be positioned at a minimum distance xmin from the reflectors in order to ensure continuity of angular coverage from one reflector to another. It can be shown that:

xmin=e/[2tg(α/2)], e being the maximum distance separating two vertices of two adjacent corner cubes and a being the angle of inclination existing between the two adjacent faces of these two corner cubes.

When the source S is in the vicinity of one of the two planes XOZ and XOY, and only in this case, the two adjacent reflectors each generate an image on the detector, these two images therefore being partially superposed. Where there is superposition, the light powers projected onto the sensors are added together. Consequently, and in this particular case, the processing of the images coming from the sensors must be capable not only of recognizing the colours of the coloured areas contained in the captured images, but also their amplitude level. The simplest procedure is to arrange a neutral filter of known attenuation on some corner cubes. For example, if the choice is made to attenuate the light levels reflected by the corner cubes Re2 and Re4 by a factor of two relative to those of the corner cubes Re1 and Re3, a global filter of transmission (0.5)^{0.5} is added on the entry faces of the corner cubes Re2 and Re4.

The choice and the arrangement of the colours on all the four reflectors make it possible to recover the two original images on the basis of a combined image.

In this configuration, it is not necessary to determine the luminance levels in the captured images precisely, but instead the relative amplitude levels of the different coloured areas with respect to one another. Thus, each coloured pixel may be assigned a simple three-digit code which depends on predetermined thresholds.

For example, the first digit represents the colour red, the second digit the colour green and the third the colour blue.

Each digit has at most five values. For example, the value 0 indicates that the colour is entirely absent from the pixel. The value 1 indicates that the colour comes from one and only one attenuated coloured area. The value 2 indicates that the colour comes from one and only one unattenuated coloured area. The value 3 indicates that the colour comes from two areas, one attenuated and the other not attenuated, and so on.

Thus, a pixel belonging to the sum of the images of the three reflectors or of the four reflectors has the following code:
For the combination of the images of the reflectors Re1, Re2 and Re3, the colour is 2r+j+2v and the code is 330;
For the combination of the images of the reflectors Re2, Re3 and Re4, the colour is j+2v+c and the code is 141;
For the combination of the images of the reflectors Re3, Re4 and Re1, the colour is 2r+2v+c and the code is 231;
For the combination of the images of the reflectors Re4, Re1 and Re2, the colour is 2r+j+c and the code is 321.
For the combination of the images of the reflectors Re1, Re2, Re3 and Re4, the colour is 2r+j+2v+c and the code is 341.

The letters r, j, v and c denote the colours red, yellow, green and cyan of the images coming separately from the reflectors.

With knowledge of the codes of the surfaces of the total image by measurement, the surfaces of each of the two to four constituent images can therefore be reconstructed using their code, i.e.:
the surfaces which are produced by each reflector but which are not combined with the surfaces of another reflector;
the surfaces which are produced by each reflector and which are combined with the surfaces of one or more other reflectors;
the two to four reflectors in question among the four.

The contour of the surfaces of uncombined colours produced separately by the reflectors, and therefore the orientation of at least one of these reflectors, is deduced therefrom.

FIG. 27 represents a circuit diagram of a part of the image analysis means of a detection device according to the invention. It comprises a plurality of functional units. The input unit “SENSOR” represents the matrix sensor. For each pixel of the matrix detector, this unit provides three “raw” video signals denoted Vr, Vv and Vb. The second unit, denoted “NORMALIZATION”, represents the normalization unit. On the basis of the signals above, it determines the level V0 corresponding to an unfiltered signal. It can be shown that either this signal V0 is present in the video signals or it can be deduced easily by knowledge of the raw coloured signals. The third unit, denoted “ENCODING”, carries out the encoding function as described above on the basis of the signals coming from the sensor and the normalization unit. The fourth unit, denoted “IMAGES”, determines the geometry and the colour of the various coloured areas coming from the reflections of the corner cubes. At most there are four different images to be analysed, each point of these images having three normalized coordinates R, G and B.

This method has two significant advantages. On the one hand, it does not employ an absolute measurement of the light levels, but is based on the local variation in the light levels on each channel R, G and B, that is to say it is not sensitive to the overall variation in power received by the sensor, due for example to the variation in the power of the source or the variation in the source/reflector distance or in the reflector/sensor distance. On the other hand, quantification of the colour videos in a small number of levels makes the device not very sensitive to the colorimetric variation of the source.

A second corner cube combination is a variant of the previous one. The optical assembly also has four adjacent corner cubes denoted Re1, Re2, Re3 and Re4, as described in FIGS. 21 and 22. In this variant, however, the reflectors Re1 to Re4 are all equipped with red, green and blue triangular filters and a neutral central triangle. The reflectors are arranged in such a way that no two coloured surfaces of the same colour are adjacent. FIG. 28 represents a possible distribution of the coloured regions of the entry faces of the four corner cubes of this optical assembly. As before, the three colours are represented by dots of different density.

In order to identify the source reflector from the isolated reflection of a given colour, the marking differentiations described above are all used. Thus, the markings have different geometrical shapes making it possible to identify the sides of the coloured triangles of the reflectors. They are unitary or doubled and with different transmission in order to differentiate the reflectors from one another, as already described in FIGS. 23 and 24. Furthermore, a similar marking is added on the sides of the central triangles of the entry faces of the reflectors. The marking is carried out in proximity to the vertices.

In the same way as in the previous case, when the source S is in the vicinity of one of the separation edges of two corner cubes, the two adjacent reflectors each generate an image on the detector, these two images therefore being partially superposed. The simpiest procedure for determining the images coming from each corner cube is to arrange a neutral filter of known attenuation on some corner cubes. For example, if the choice is made to attenuate the light levels reflected by the corner cubes Re2 and Re4 par by a factor of two relative to those of the corner cubes Re1 and Re3, a global filter of transmission (0.5)^{0.5} is added on the entry faces of the corner cubes Re2 and Re4.

By using coding identical to that described above, it can then be shown that, with knowledge of the codes of the surfaces of the total image by measurement, the surfaces of each of the two to four constituent images can therefore be reconstructed using their code, i.e.:
the surfaces which are produced by each reflector but which are not combined with the surfaces of another reflector;
the surfaces which are produced by each reflector and which are combined with the surfaces of one or more other reflectors;
the two to four reflectors in question among the four.

The contour of the surfaces of uncombined colours produced separately by the reflectors, and therefore the orientation of at least one of these reflectors, is deduced therefrom.

A third corner cube combination has eight adjacent solid corner cubes in the form of trirectangular tetrahedra with the same vertex O, referenced Re1 to Re8. The eight equilateral entry faces form a regular convex octahedron PRQUVW. This is represented in FIGS. 29 and 30. FIG. 29 represents a perspective view of the octahedron, and FIG. 30 represents an exploded view showing the various corner cubes, referenced Re1 to Re8.

Each corner cube reflector is provided with three coloured triangular filters with marking and one neutral filter, also with marking, as described above. As in the case of the previous optical combinations with four corner cubes, there are two variants of the octahedron of optical assembly.

In a first variant, all the corner cubes have the same triplet of coloured regions, which may be red, green and blue. In a second variant, the entry faces of four corner cubes have the same first triplet of coloured regions and the faces of the four other corner cubes have the same second triplet of coloured regions, which is different from the first triplet of coloured regions. By suitably distributing the colours, shapes, transmission and number of the indentations of the marks, it is possible to identify each corner cube by its image on the sensors. The solid angle covered is therefore 4π steradians, i.e. the entire space.

In a second variant, each of the eight corner cube reflectors combined to form an octahedron is provided with the same three coloured triangular filters with marking and a neutral filter, also with marking. A global filter of transmission (0.5)^{0.5} is applied onto the entry face of four of the corner cubes. When the marking of a corner cube comprises two indentations, the shape of the indentation closest to the vertex is always used to distinguish the side and the vertex of the coloured or white triangle of the entry face. The second indentation may have three different shapes. The images obtained on the detector thus make it possible to distinguish the reflections provided by the reflectors from one another.

A fourth corner cube combination has twelve corner cubes denoted Re1 to Re12, which are not adjacent via their lateral faces. Each corner cube reflector is provided on its front face with three coloured triangular filters with marking and one neutral filter, also with marking, as described above. The 12 reflectors with vertices O1 to O12, which are in the shape of triangular pyramids, are positioned and oriented with respect to a regular convex dodecahedron of arbitrary size, as can be seen in FIG. 31 which represents a front view of this optical assembly D_{CCC}. The centre of the dodecahedron is denoted O, and the centres of each of its twelve pentagonal faces are denoted F1 to F12. These twelve faces delimit 12 adjacent angular sectors of vertex O, which correspond to pentagonal pyramids with an individual solid angle Ωd equal to π/3 steradians. In FIG. 31, only the corner cubes Re1 to Re6 are visible.

The arrangement of the reflectors has the following characteristics and properties:
The axis of each reflector Rei which corresponds to the diagonal of the corner cube of vertex Oi coincides with one of the axes OFi of the dodecahedron, and the angle between two neighbouring axes is therefore close to 62°;
Each reflector Rei is oriented around its axis so that its angular field, with a solid angle Ωr equal to π/2 sr, contains almost all of the angular sector of the pentagonal pyramid of solid angle Ωd corresponding to one twelfth of the dodecahedron. The lack of angular coverage lying in part of the periphery of the field of each reflector is compensated for by the neighbouring reflector or reflectors. Consequently, with the dodecahedron covering the solid angle of 4π continuous steradians by design, the set of twelve corner cube reflectors also covers 4π steradians continuously;
The peripheral angular field of each reflector is locally common to the peripheral angular field of at least one of the neighbouring reflectors. At the periphery of a reflector, consequently, the peripheral reflection of at least two reflectors is collected, notably for mirror reflectors, thus ensuring a minimum size for the reflection, as required above:
The vertices of the reflectors Oi of given height h corresponding to half the diagonal of the cube, are positioned on the axes OFi at the same distance OOi, this distance being such that the volume of each reflector is entirely contained inside the associated pentagonal pyramid of vertex O, so as to ensure physical separation between the reflectors. The geometrical consequences are as follows:
The twelve vertices Oi lie on a sphere of centre O;
The twelve front faces of the reflectors are tangent at their middle to a sphere of centre O;
The radius d, equal to OOi, of the first sphere is at least dmin, which is approximately equal to 1.23 h;
The distance e, equal to OiOj, between two neighbouring vertices has a minimum value emin which is approximately equal to 0.65 h;
The angular field common to two neighbouring reflectors has a minimum value of about 18 mrad. For the configuration corresponding to the minimum value of the distance OOi, i.e. dmin, the distance between the point source S and the centre O, for which a reflection is always ensured, has the value Dmin which is approximately equal to 4.6 h.

FIG. 31 represents a front view of the combined reflector D_{CCC} and corresponds to the orthogonal projection perpendicularly to the face of centre F1 of the central reflector Re1. In this figure, the size of the dodecahedron is that for which its faces are coplanar and concentric at Fi with the faces of the reflectors. Only the front faces of the reflectors Re1 to Re6 of centre F1 to F6 are represented, the reflectors Re7 to Re12 not represented are respectively the mirror images of the reflectors Re1 to Re6 with respect to the centre O of the dodecahedron. The particular edges a1 to a5 of the dodecahedron give the orientation, mentioned above, of each of the six reflectors Rei around its axis OFi, as follows:
the front face of Re1 close to a1 is parallel to a1,
the front face of Re2 close to a2 is parallel to a2,
the front face of Re3 close to a3 is parallel to a3,
the front face of Re4 close to a4 is parallel to a4,
the front face of Re5 close to a5 is parallel to a5,
the front face of Re6 close to a1 is parallel to a1.

This FIG. 31 corresponds, for a given dimension h of the reflectors, to the most compact configuration of the combined reflector, namely OOi equal to dmin. Consequently, for each reflector, two of the three vertices of the front face lie on the edges of the dodecahedron. Furthermore, except for Re6, these two vertices are coincident with the corresponding vertices of the neighbouring reflectors.

It is, of course, possible to use simple variants of this dodecahedron in order to produce less compact solutions. Here again, by suitably distributing the colours, shape, transmission and number of the indentations of the marks, it is possible to identify each corner cube by its image on the sensors.

In a variant of this fourth combination, the optical element above may be reduced to only six tetrahedral reflectors, thus covering an angular half-space, i.e. 2π steradians. The external shape of the combined reflector is circumscribed in a hemisphere, FIG. 32 representing such an arrangement DD_{CCC} in perspective. Only four of the entry faces of the six corner cubes are visible in this figure.

The detection systems according to the invention are used mainly in helmet posture detection applications, the optical assembly comprising corner cubes being mounted on the said helmet. The corner cube combinations above may all be mounted on a helmet.

When the optical element comprising the corner cubes is the dodecahedron above with twelve corner cubes, one of the corner cubes is omitted, for example the reflector Re12, in order to be able to fix the optical element on the helmet. Eleven tetrahedral reflectors Re1 to Re11 are kept for the measurement. FIG. 33 represents this optical element D_{CCC} mounted on the rear of a helmet H_{T}. In this figure, the helmet is represented in the reference frame (X, Y, Z), and is seen from the rear. The external shape of the combined reflector is circumscribed in a sphere, and the solid angle covered is then 11π/3 sr, which is entirely compatible with the angular measurement fields of posture detection systems.

When the optical element comprising the corner cubes is a semi-dodecahedron as above with six corner cubes, it is necessary to arrange two of them on the sides of the helmet, as can be seen in FIG. 34. The combinations DD_{CCC} are centred at the left and right on the helmet. Each optical element DD_{CCC} covers an angular half-space bounded by one of the two planes Pd and Pg with orientations close to that of the vertical symmetry plane (x, z) of the helmet. The two optical elements use the same fixed electro-optical device comprising a point source and the matrix sensor or sensors.

1. System for detecting the posture of an object which is mobile in space, comprising a fixed electro-optical device of known orientation comprising at least a first emission source, image analysis means and an optical assembly comprising at least one optical corner cube arranged on the mobile object, wherein:
the entry face of the corner cube is divided into at least three separate coloured regions, each coloured region having a spectral transmission filter, each filter transmitting only a predetermined spectral band different from those of the other spectral transmission filters;
each side of the said coloured regions having a specific marking making it possible to identify this said side;
the spectrum of the emission source having at least a spectral width equal to the sum of the spectral bands of the said spectral transmission filters;
the fixed electro-optical device of known orientation comprises at least one colour matrix sensor sensitive to the spectral band of the emission source;
the image analysis means comprise means for determining shapes and geometrical characteristics in the images received by the colour matrix sensor and for analysing the vanishing lines, making it possible to find the position and the orientation of the optical corner cube.

2. Detection system according to claim 1, wherein, the face of the corner cube being triangular, it is divided into three identical coloured triangular regions.

3. Detection system according to claim 2, wherein, the entry face of the corner cube being triangular, it has three identical coloured triangular regions enclosing a transparent triangular central region without a spectral transmission filter.

4. Detection system according to claim 1, wherein the specific markings are geometrical and/or photometric markings.

5. Detection system according to claim 1, wherein the optical assembly has four adjacent tetrahedral corner cubes of identical shapes, each corner cube having one entry face, two reflective lateral faces common to two other corner cubes, and a reflective third lateral face located in a plane common to the other third lateral faces of the three other corner cubes, the said third lateral faces thus forming a square, the four entry faces and the said square forming a pentahedron in the form of a square-based pyramid.

6. Detection system according to claim 1, wherein the optical assembly has four tetrahedral corner cubes of identical shapes arranged symmetrically around a single vertex common to the four corner cubes, each corner cube having one entry face.

7. Detection system according to claim 5, wherein the entry faces of the four corner cubes comprise the same first triplet of coloured regions.

8. Detection system according to claim 5, wherein the entry fares of the first and second corner cubes comprise the same first triplet of coloured regions, and in that the entry faces of the third and fourth corner cubes comprise the same second triplet of coloured regions, which is different from the first triplet of coloured regions.

9. Detection system according to claim 5, wherein the entry faces of the first and second corner cubes have a neutral filter of predetermined transmission.

10. Detection system according to claim 5, wherein the specific marking of the sides of the coloured regions of each entry face is arranged so that this face can be distinguished from the three others.

11. Detection system according to claim 1, wherein the optical assembly has eight adjacent tetrahedral corner cubes of identical shapes, each corner cube having one entry face, and three reflective lateral faces common to three other corner cubes, the eight entry faces forming a regular octahedron.

12. Detection system according to claim 11, wherein the entry faces of the eight corner cubes comprise the same first triplet of coloured regions.

13. Detection system according to claim 11, wherein the entry faces of the first, second, third and fourth corner cubes comprise the same triplet of coloured regions, and in that the entry faces of the fifth, sixth, seventh and eighth corner cubes comprise the same second triplet of coloured regions, which is different from the first triplet of coloured regions.

14. Detection system according to claim 11, wherein the entry faces of four corner cubes comprise a neutral filter of predetermined transmission.

15. Detection system according to claim 11, wherein the specific marking of the sides of the coloured regions of each entry face is arranged so that this face can be distinguished from the seven others.

16. Detection system according to claim 1, wherein the optical assembly has a plurality of corner cubes the entry faces of which are oriented and positioned along the pentagonal faces of a regular dodecahedron or of a part of a dodecahedron, each entry face being oriented in each pentagonal face so that the optical assembly produces a reflection on the detector in a range of determined orientation, the specific marking of the sides of the coloured regions of each entry face being arranged so that this entry face can be distinguished from all the others.

17. Detection system according to claim 1, wherein the fixed electro-optical device has at least one point emission source and only optical components having a zero or quasi-zero optical power, that is to say plane mirrors or semi-reflective plane plates, the separation between the point emission source and the light reflected by the corner cube or cubes being produced by means of a semi-reflective plane plate.

18. Detection system according to claim 1, wherein the analysis means comprise an electronic preprocessing arranged at the output of the matrix sensor or sensors and making it possible to assign a three-component code to each pixel, each component being representative of a predetermined spectral band, each component being encoded over a limited number of levels representing the absence or presence of light received in the said spectral band.

19. Flight helmet, which comprises at least one optical corner cube, the entry face of which is divided into at least three separate coloured regions, each coloured region having a spectral transmission filter, each filter transmitting only a predetermined spectral band different from those of the other spectral transmission filters, each side of the said coloured regions having a specific marking making it possible to identify this said side, the said corner cube being intended to operate in a system for detecting the posture of an object which is mobile in space, comprising a fixed electro-optical device of known orientation comprising at least a first emission source, image analysis means and an optical assembly comprising at least one optical corner cube arranged on the mobile object, wherein:
the entry face of the corner cube is divided into at least three separate coloured regions, each coloured region having a spectral transmission filter, each filter transmitting only a predetermined spectral band different from those of the other spectral transmission filters;
each side of the said coloured regions having a specific marking making it possible to identify this said side;
the spectrum of the emission source having at least a spectral width equal to the sum of the spectral bands of the said spectral transmission filters;
the fixed electro-optical device of known orientation comprises at least one colour matrix sensor sensitive to the spectral band of the emission source;
the image analysis means comprise means for determining shapes and geometrical characteristics in the images received by the colour matrix sensor and for analysing the vanishing lines, making it possible to find the position and the orientation of the optical corner cube.

20. Flight helmet according to claim 19, wherein it comprises at least one regular dodecahedron having a plurality of identical pentagonal faces, each having a corner cube arranged so that each entry face of the said corner cube is located and centred on one of the said pentagonal faces and oriented in this pentagonal face so that the optical assembly produces a reflection on the detector in a range of determined orientation, the specific marking of the sides of the coloured regions of each entry face being arranged so that this entry face can be distinguished from all the others.

21. Flight helmet according to claim 19, wherein it comprises at least two identical regular semi-dodecahedra, each having six identical pentagonal faces, each having a corner cube arranged so that each entry face of the said corner cube is located and centred on one of the said pentagonal faces and oriented in this pentagonal face so that the optical assembly produces a reflection on the detector in a range of determined orientation, the specific marking of the sides of the coloured regions of each entry face being arranged so that this entry face can be distinguished from all the others.

22. Detection system according to claim 6, wherein the entry faces of the four corner cubes comprise the same first triplet of coloured regions.

23. Detection system according to claim 6, wherein the entry faces of the first and second corner cubes comprise the same first triplet of coloured regions, and in that the entry faces of the third and fourth corner cubes comprise the same second triplet of coloured regions, which is different from the first triplet of coloured regions.

24. Detection system according to claim 6, wherein the entry faces of the first and second corner cubes have a neutral filter of predetermined transmission.

25. Detection system according to claim 6, wherein the specific marking of the sides of the coloured regions of each entry face is arranged so that this face can be distinguished from the three others.
